(19) United States
(12) Patent Application Publication
(10) Pub. No.: US 2010/0207826 A1
(43) Pub. Date: Aug. 19, 2010

(54) ANTENNA SYSTEM USING HOUSINGS OF ELECTRONIC DEVICE AND ELECTRONIC DEVICE COMPRISING THE SAME

(76) Inventors: Byung Hoon Ryou, Seoul (KR); Won Mo Sung, Gyeonggi-do (KR); Myo Geun Yang, Gyeonggi-do (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/738,632

(22) PCT Filed: Jul. 17, 2008
(86) PCT No.: PCT/KR08/04180

§ 371 Date: Apr. 16, 2010

(30) Foreign Application Priority Data
Oct. 23, 2007 (KR) 10-2007-0106369

(51) Int. Cl. H01Q 1/24

(52) U.S. Cl. 343/702

(57) ABSTRACT

An antenna system using a housing of an electronic device and an electronic device having the same are provided. The antenna system includes a first housing of an electronic device, which is formed of a conductive material and connected to a ground plane, and a second housing of the electronic device, which is arranged apart from the first housing by a predetermined distance and formed of a conductive material. A first end of the second housing is connected to a first power supply element. The first housing and the second housing are connected to each other through a first connecting element arranged apart from the first end of the second housing by a pre-determined distance. The antenna system secures a wide radiator to improve antenna efficiency and uses the housings of the electronic device as an antenna without using an additional element to reduce the size of the electronic device.

### TECHNICAL FIELD

The present invention relates to an antenna system using a housing of an electronic device and an electronic device having the same, and more particularly, to an antenna system using a housing made of a metal as an antenna radiator and an electronic device having the same.

### BACKGROUND ART

Electronic devices such as notebook computers, cellular phones, PDA and the like have housings for protecting internal circuits and forming the external appearances thereof. While the shape and structure of a housing depend on the shape of an electronic device employing the housing, a recently widely used electronic device has a folded structure including upper and lower housings connected to each other using a hinge.

A conventional electronic device having the folded structure is described with reference to FIG. 1. FIG. 1(a) is a perspective view of a notebook computer and FIG. 1(b) is a perspective view of a cellular phone. The notebook computer includes an upper body 120 and a lower body 110 which are foldably combined with each other using a hinge 150. The upper body 120 includes a display 140 such as a liquid crystal display (LCD) for displaying images to a user and a circuit for driving the display 140. The driving circuit can be mounted in the upper body 120. The lower body 110 connected with the upper body 120 through the hinge 150 includes input units such as a keypad 130 and a touch pad 170 for receiving an input from the user and a main circuit board including a central processing unit (CPU). The main circuit board is mounted in the lower body 110. Similarly, the cellular phone illustrated in FIG. 1(b) includes an upper body 120 having a display 140 and a lower body 110 having a keypad 130, which are foldably combined with each other using a hinge 150. The lower body 110 can further include a microphone 160 for receiving the voice of a user.

The upper body 120 and the lower body 110 respectively include housings for forming the external appearance of the electronic device and protecting internal elements of the electronic device. Although the housings are formed of a plastic material in general, a metal has been increasingly used as the material of the housings recently.

The electronic device must have an antenna for transmitting and receiving radio signals in order to use a mobile telephone service or a wireless network. A conventional electronic device has a separate antenna mounted therein or connected to an antenna through an external connector.

However, the number of components included in the electronic device increases as the electronic device has multiple functions and the inner space of the electronic device decreases. Accordingly, installation of an antenna inside the electronic device prevents the inner space of the electronic device from being effectively used and hinders a reduction in the size of the electronic device. Furthermore, the performance of the antenna is abruptly deteriorated due to a housing when the housing is made of a metal.

When an external antenna is used for the electronic device, the antenna is projected from the electronic device and thus the beauty of the external appearance of the electronic device is spoiled. In the case of a detachable antenna, a user should carry the antenna and the antenna has the same problem as that of the external antenna when the detachable antenna is combined with the electronic device.

### DISCLOSURE OF INVENTION

### Technical Problem

Accordingly, the present invention has been made to solve the above-mentioned problems occurring in the conventional art, and a primary object of the present invention is to provide an antenna capable of transmitting and receiving radio signals without occupying the inner space of an electronic device or marring the beauty of the external appearance of the electronic device and an electronic device employing the same.

### Technical Solution

To accomplish the object of the prevent invention, according to an aspect of the present invention, there is provided an antenna system comprising a first housing of an electronic device, which is formed of a conductive material and connected to a ground plane, a second housing of the electronic device, which is arranged apart from the first housing by a predetermined distance and formed of a conductive material and has a first side connected to a first power supply element, and a first connecting element arranged apart from the first side of the second housing by a predetermined distance to connect the first housing and the second housing to each other.

The second housing may have a rectangular shape and the length of the longer side of the rectangular shape may be greater than ¼ of the resonant wavelength of the antenna system.

The distance between the first side of the second housing and the first connecting element may be determined such that the antenna system resonates in a target frequency band. The distance between the first housing and the second housing may be determined such that the antenna system has a target bandwidth. The first connecting element may include an inductor.

A second side of the second housing may be connected to a second power supply element and the antenna system may further comprise a second connecting element arranged apart from the second side of the second housing by a predetermined distance to connect the first housing and the second housing to each other.

A signal line connected to the ground plane may be arranged between the first connecting element and the second connecting element.

The first housing and the second housing may be foldably combined with each other by using a hinge.

According to another aspect of the present invention, there is provided an electronic device having a wireless communication function and including an antenna system comprising a first housing formed of a conductive material and connected to a ground plane, a second housing that is arranged apart from the first housing by a predetermined distance and formed of a conductive material and has a first side connected to a first power supply element, and a first connecting element arranged apart from the first end of the second housing by a predetermined distance to connect the first housing and the second housing to each other.

The second housing may have a rectangular shape and the length of the longer side of the rectangular shape may be greater than 1/4 of the resonant wavelength of the antenna system.

The distance between the first side of the second housing and the first connecting element may be determined such that the antenna system resonates in a target frequency band. The distance between the first housing and the second housing may be determined such that the antenna system has a target bandwidth. The first connecting element may include an inductor.

A second side of the second housing may be connected to a second power supply element and the antenna system may further comprise a second connecting element arranged apart from the second side of the second housing by a predetermined distance to connect the first housing and the second housing to each other. The electronic device may further comprise a signal line arranged between the first connecting element and the second connecting element and connected to the ground plane.

The first housing and the second housing may be foldably combined with each other by using a hinge.

### ADVANTAGEOUS EFFECTS

According to the present invention, an antenna that does not occupy the inner space of an electronic device or mar the beauty of the external appearance of the electronic device and an electronic device having the same can be obtained. Furthermore, a diversity antenna or a multiband antenna system can be easily constructed without using an additional antenna element. Moreover, the antenna does not occupy the inner space of the electronic device, and thus the size of the electronic device can be reduced and diversification of the design of the electronic device can be achieved.

### BRIEF DESCRIPTION OF DRAWINGS

Further objects and advantages of the invention can be more fully understood from the following detailed description taken in conjunction with the accompanying drawings, in which:

FIG. 1 illustrates conventional electronic devices;

FIG. 2 illustrates an antenna system according to an embodiment of the present invention;

FIG. 3 is a graph illustrating a standing wave ratio of the antenna system according to an embodiment of the present invention;

FIG. 4 illustrates an antenna system according to another embodiment of the present invention;

FIG. 5 is a graph illustrating an S-parameter of an antenna according to an embodiment of the present invention;

FIG. 6 illustrates an antenna system according to another embodiment of the present invention; and

FIG. 7 is a block diagram of an electronic device according to an embodiment of the present invention.

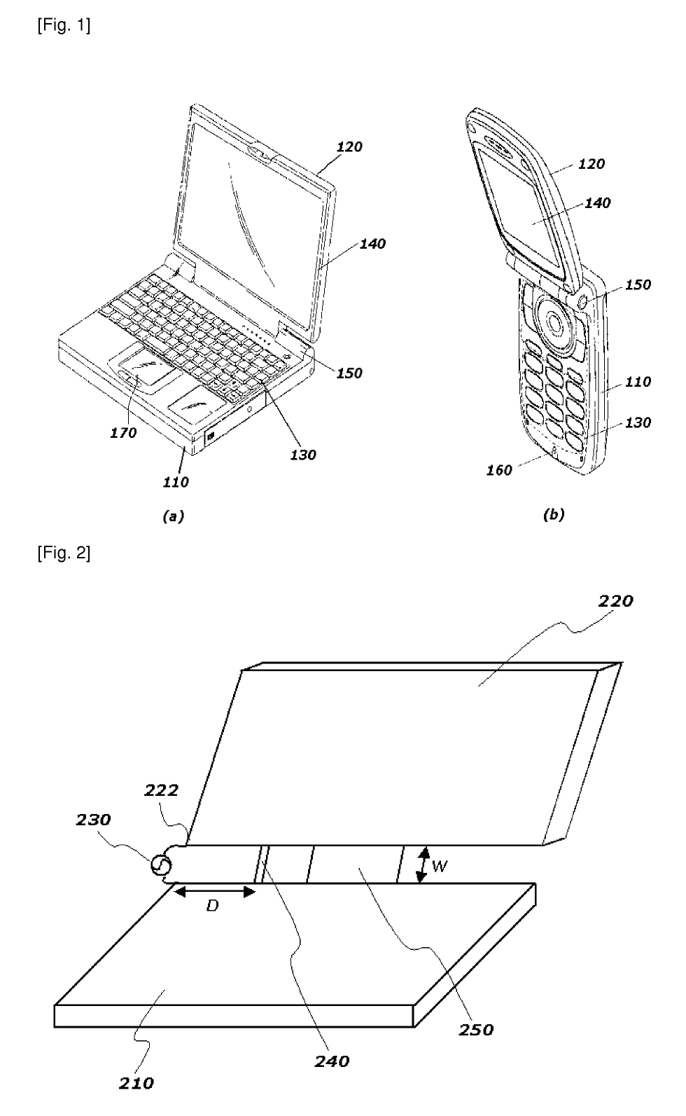

### BEST MODE FOR CARRYING OUT THE INVENTION

The present invention will now be described more fully with reference to the accompanying drawings, in which exemplary embodiments of the invention are shown. The invention may, however, be embodied in many different forms and should not be construed as being limited to the embodiments set forth herein. In the specification, an electronic device is referred to as a device having a wireless communication function and including a housing, such as a PDA, a notebook computer and a desktop computer.

FIG. 2 illustrates an antenna system according to an embodiment of the present invention. The antenna system includes a first housing 210 and a second housing 220 arranged apart from the first housing 210 by a predetermined distance. The first and second housings 210 and 220 can be made of a conductive material, for example, aluminum.

The first housing 210 is included in an upper body of an electronic device and a variety of elements such as a CPU, a communication module and a speaker can be mounted inside the first housing 210. The first housing 210 is connected to a ground plane and has the same potential as that of the ground plane for an internal circuit of the electronic device.

The second housing 220 is arranged apart from the first housing 210 by the predetermined distance and one side of the second housing 220, for example, a corner 222 of the second housing, is connected to the power supply element 230. The power supply element 230 is also connected to the first housing 210, and thus the power supply element 230 is substantially connected between the ground and the second housing 220. Accordingly, the first housing 210 and the second housing 220 have configurations similar to that of a dipole antenna.

However, the sizes of the first housing 210 and the second housing 220 are determined by the size of the electronic device and the first and second housings 210 and 220 do not have an electrical length for operating as a dipole antenna. Since a frequency used for wireless communication is in the range of several hundred MHz to several GHz, the length of the longer side of each of the first and second housings 210 and 220 is greater than λ/4 corresponding to an electrical length of a radiator of a general dipole antenna when the first and second housings 210 and 220 are used for a notebook computer and have a rectangular shape.

To solve this problem, a connecting element 240 for connecting the first housing 210 and the second housing 220 to each other is arranged at a position located apart from the side 222 of the second housing 220, which is connected to the power supply element 230, by a predetermined distance. In this case, although current flows from the side 222 connected to the power supply element 230 to the point connected to the connecting element 240 to cause a phase variation, a portion after the point connected to the connecting element 240 becomes an in-phase circuit according to connection with the ground plane. Accordingly, the first housing 210 and the second housing 220 operate similarly to a slot antenna and electromagnetic waves are radiated mainly in portions of the first and second housings 210 and 220, which range from the side 222 connected to the power supply element 230 to the point connected to the connecting element 240 and substantially function as a slot.

In this configuration, a distance D between the side 222 and the connecting element 240 has the largest influence on determination of an antenna resonance frequency. The antenna can operate at a target resonance frequency when the distance D approximates ¼ of the wavelength of the target resonance frequency. Furthermore, a gap W between the first housing 210 and the second housing 220 affects the impedance of the antenna, and thus the bandwidth of the antenna can be adjusted by controlling the gap W. However, the distance D and the gap W affect the resonance frequency and the bandwidth of the antenna and do not determine antenna characteristics, and thus it is required to finely adjust the distance D and the gap W in order to obtain accurate antenna characteristics, which is easily understood by those of ordinary skill in the art.

In general, the electronic device includes a signal line 250 for transmitting signals to a display included in the second housing 220. The signal line 250 also has a ground plane for smooth transmission of signals. Accordingly, the signal line 250 must be arranged outside the connecting element 240 such that the operation of the aforementioned slot antenna is not obstructed by the signal line 250.

The antenna system according to the current embodiment of the invention uses the first and second housings 210 and 220 as a radiator, and thus the antenna system can secure a radiation area much larger than that of a conventional antenna. Accordingly, the antenna system has a high antenna gain and can achieve broadband characteristics. An increase in the radiation area can reduce a specific absorption ratio (SAR) and the influence of external environment.

Furthermore, since there is no need to install an additional antenna element, the inner space of the electronic device can be effectively used, the electronic device can be designed freely and the size of the electronic device can be reduced. Moreover, deterioration of the antenna performance due to a metal housing can be prevented.

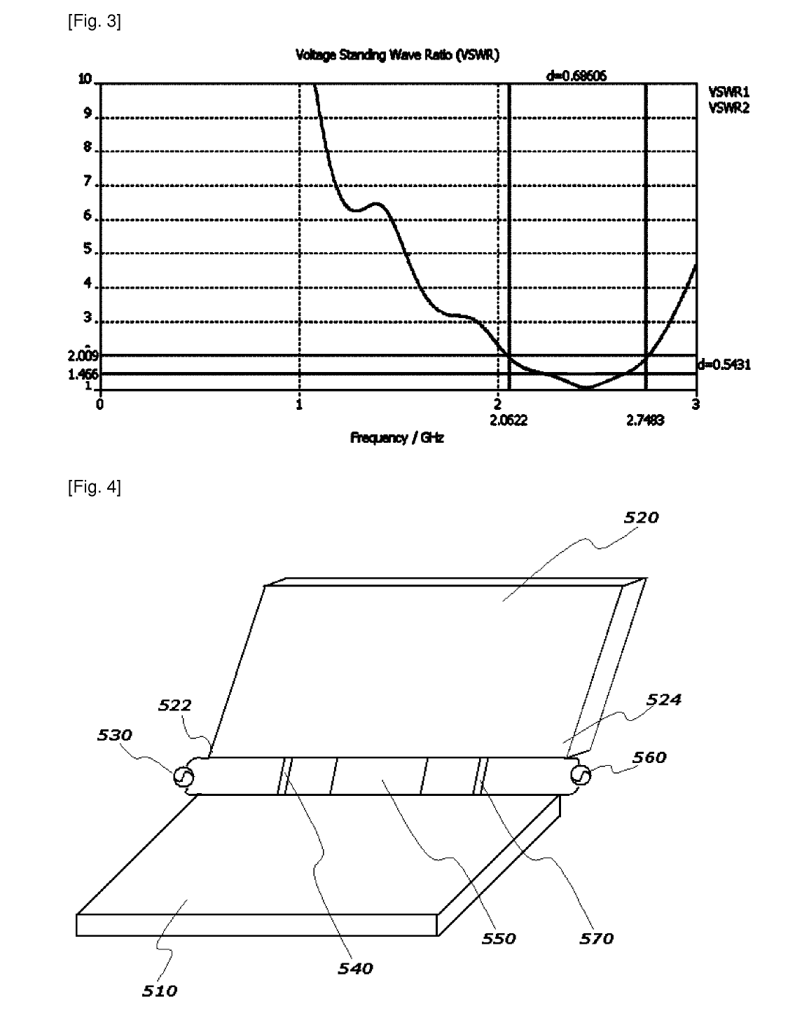

The antenna according to the current embodiment of the present invention is virtually constructed and simulated and the result of the simulation is shown in FIG. 3. Microwave Studio of CST was used as a simulation tool, a housing size was 300×430 mm², the distance D was 50 mm and the gap W was 5 mm.

Current is most intensive in the slot between the first and second housings 210 and 220, and thus it can be known that intensive radiation occurs in the slot. Furthermore, it can be confirmed that radiation also occurs at the left sides of the housings 210 and 220.

FIG. 3 illustrates a voltage standing wave ratio of the antenna system. A target frequency band is set to 2.4 GHz that is used for Bluetooth™ or WiFi™. As illustrated in FIG. 3, a wide bandwidth of about 700 MHz on the basis of VSWR=2 can be obtained.

FIG. 4 illustrates an antenna system according to another embodiment of the present invention. The antenna system includes a first housing 510 connected to a ground plane and a second housing 520 arranged apart from the first housing 510 by a predetermined distance.

One side 522 of the second housing 520 is connected to a first power supply element 530 and a first connecting element 540 is located apart from the side 522 of the second housing 520 by a predetermined distance. The first housing 510 and the second housing 520 are connected to each other through the first connecting element 540. The first power supply element 530 is connected between the first housing 510 and the second housing 520.

A second power supply element 560 is connected to the other side 524 of the second housing 520 and a second connecting element 570 is located apart from the side 524 of the second housing 520 by a predetermined distance. The first housing 510 and the second housing 520 are connected to each other through the second connecting element 570. The second power supply element 560 is also connected to the first housing 510.

The two power supply elements 530 and 560 are respectively connected to both sides 522 and 524 of the second housing 520 and the two connecting elements 540 and 570 are respectively located apart from the two power supply elements 530 and 540 and connect the first housing 510 and the second housing 520 to each other, and thus the antenna system according to the current embodiment of the present invention includes two antennas. Specifically, a region from the point to which the first power supply 530 is connected to the first connecting element 540 becomes a first antenna slot and a region from the point to which the second power supply 560 is connected to the second connecting element 570 becomes a second antenna slot. Accordingly, the antenna system according to the current embodiment of the present invention can operate as a diversity antenna. Otherwise, the antenna system according to the current embodiment of the present invention can operate as a multiband antenna by making the two antenna slots have different lengths such that the two antenna slots have different resonance frequencies.

When the two antennas simultaneously operate, it is required to secure isolation between the two antennas. To achieve this, the antenna system according to the current embodiment of the present invention uses a signal line 550. The signal line 550 is connected to the ground plane in order to transmit signals, and thus the two antennas can be isolated from each other according to the signal line 550. Accordingly, the two antennas can be isolated from each other without affecting operations thereof by arranging the signal line 550 between the first connecting element 540 and the second connecting element 570, preferably, at the center of an electronic device employing the first and second housings 510 and 520.

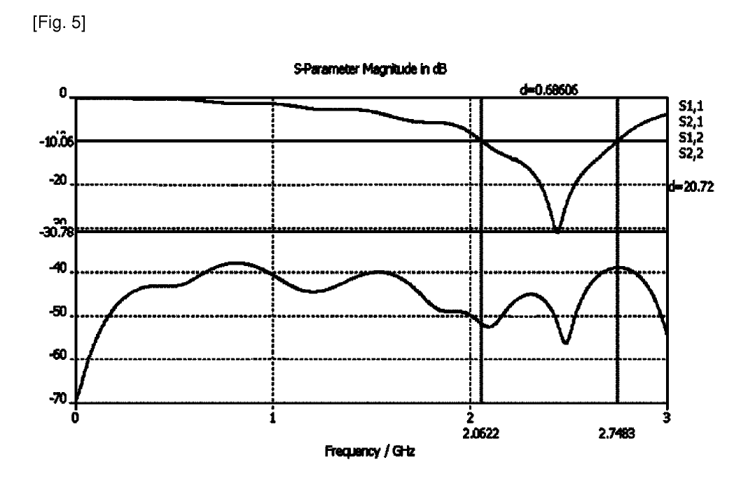

An antenna is constructed under the condition described with reference to FIG. 4 and simulated and a simulation result is shown in FIG. 5. Referring to FIG. 5, S12 parameter is relatively low in a bandwidth determined by S22 parameter, and thus it can be confirmed that two antennas are satisfactorily isolated from each other.

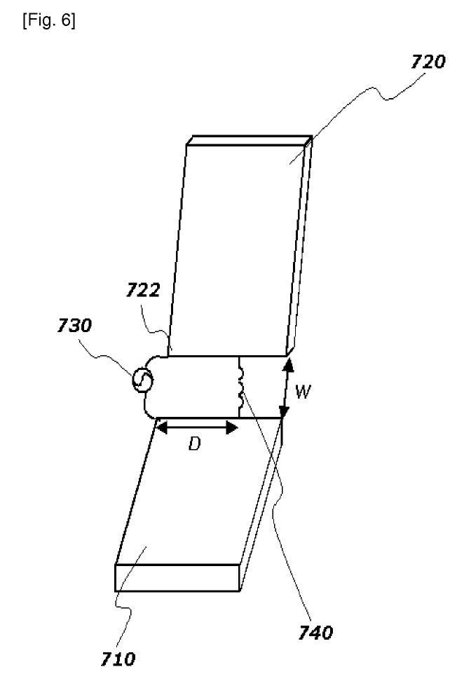

Meantime, a housing may have a size that is so small that an antenna operation at a target resonance frequency is difficult to secure. For example, the length of the longer side of a housing of a cellular phone may shorter than λ/4. The antenna system of the present invention can be applied to even this case, which is explained with reference to FIG. 6.

Referring to FIG. 6, an antenna system includes a first housing 710 connected to a ground plane and a second housing 720 arranged apart from the first housing 710 by a predetermined distance. One side 722 of the second housing 720 is connected to a power supply element 730 that is connected to the first housing 710 and grounded. The first housing 710 and the second housing 720 are connected to each other through a connecting element 740 at a point located apart from the point to which the power supply element 730 is connected by a distance D.

As described above, the resonance frequency of the antenna system according to the current embodiment of the invention is determined mainly by the distance D. However, a target resonance frequency may not be achieved when the sizes of the housings 710 and 720, particularly, the lengths of sides of the housings 710 and 720, to which the connecting element 740 is connected, are not sufficiently large.

To solve this problem, the antenna system according to the current embodiment of the invention employs an inductor as the connecting element 740. In this case, a substantial electric length is extended according to phase retardation effect of the inductor. Accordingly, the inductance of the inductor can be controlled to extend the distance D even though the sizes of the housings 710 and 720 are restricted, and thus the target resonance frequency can be achieved. Although the inductor itself can be used as the connecting element 740, the connecting element 740 may include an inductor and other elements.

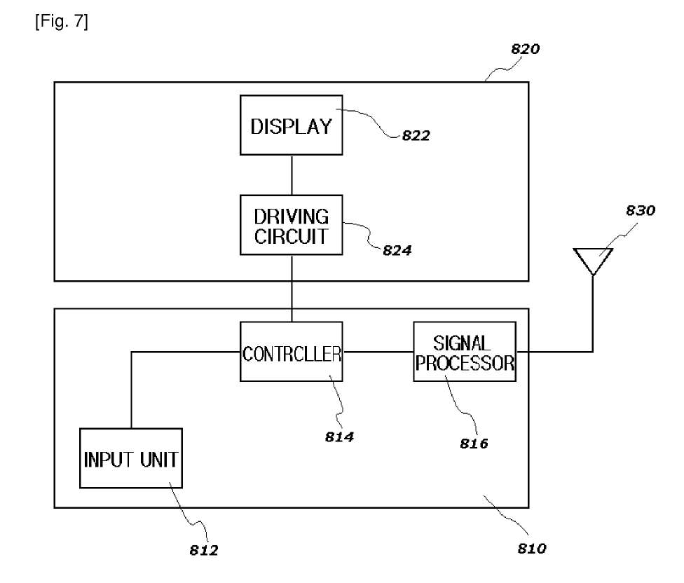

According to another embodiment of the present invention, an electronic device employing the antenna systems according to the aforementioned embodiments is provided, which will now be explained with reference to FIG. 7.

FIG. 7 is a block diagram of the electronic device according to an embodiment of the present invention. The electronic device includes an upper body 820 and a lower body 810 and has an antenna 830 for wireless communication. Specifically, the electronic device may have a local area network (LAN) wireless communication function such as Bluetooth™ and WiFi™ and may be constructed to use mobile communication services such as GSM, PCS, HSDPA and so on. Furthermore, the antenna 830 can be constructed to receive mobile broadcasting services such as DMB, MediaFLO, DVB-H and so on.

The upper body 820 may include a display 822 such as a LCD or plasma display panel (PDP) and a driving circuit 824 for driving the display 822. The display 822 and the driving circuit 824 are protected by a metal housing.

The lower body 810 includes a controller 814 including a CPU for controlling the system. The controller 814 executes a variety of programs such as an operating system and an application program such that the electronic device performs various functions. Furthermore, the controller 814 is connected to an input unit 812 such as a keyboard, a keypad, a mouse, a touch pad or the like, drives and controls the input unit 812. An input signal from the input unit 812 can be applied to the controller 814 to provide information required for the controller 814 to execute a program or control the operation of the controller 814.

The controller 814 is connected to a signal processor 816 to perform communication. The signal processor 816 decodes/encodes a signal and appropriately converts the signal such that the controller 814 can communicate with an external device and/or network wirelessly and performs wireless communication through the antenna 830. Specifically, the signal processor 816 encodes and modulates a signal received from the controller 814, transmits the modulated signal through the antenna 830, demodulates and decodes a signal received through the antenna 830 and provides the decoded signal to the controller 814.

The controller 814, the input unit 812 and the signal processor 816 included in the lower body 810 are protected by a metal housing.

In the aforementioned electronic device, the antenna 830 is constructed using the metal housings of the upper body 20 and the lower body 810. That is, an antenna radiator is constructed using the two metal housings arranged apart from each other by a predetermined distance and the metal housings are connected to control the resonance frequency of the antenna so as to achieve the antenna that resonates in a required frequency band. The configuration of the antenna 830 is substantially identical to those of the antennas according to the aforementioned embodiments of the present invention so that detailed explanation thereof is omitted.

As described above, the antenna 830 can be constructed using the housings of the electronic device to increase the area of the antenna radiator and improve the efficiency of the antenna. Furthermore, the electronic device does not include an additional antenna element, and thus the inner space of the electronic device can be effectively used and the size of the electronic device can be reduced. Moreover, two antennas can be obtained using both sides of the housings, and thus a diversity antenna or a multiband antenna system can be easily constructed.

While the present invention has been particularly shown and described with reference to exemplary embodiments thereof, it will be understood by those of ordinary skill in the art that various changes in form and details may be made therein without departing from the spirit and scope of the present invention. In particular, the functions of the first housing and the second housing can be exchanged with each other in the aforementioned embodiments, which will be easily understood by those of ordinary skill in the art. The above-described functional blocks can be embodied as various known elements such as electronic circuits, integrated circuits and application specific integrated circuit (ASIC) and they can be respectively constructed or at least two of them can be integrated. Constituent elements described as separate means are simply functionally distinguished from each other and can be physically embodied as a single means and a single constituent element can be embodied as a combination of several constituent elements. Various embodiments of the invention may be provided separately or in any suitable subcombination. Accordingly, the scope of the present invention should not be limited to the description of the embodiments, but defined by the accompanying claims and equivalent thereof.

1. An antenna system comprising:
a first housing of an electronic device, which is formed of a conductive material and connected to a ground plane;
a second housing of the electronic device, which is arranged apart from the first housing by a predetermined distance and formed of a conductive material and has a first side connected to a first power supply element; and
a first connecting element arranged apart from the first side of the second housing by a predetermined distance to connect the first housing and the second housing to each other.

2. The antenna system according to claim 1, wherein the second housing has a rectangular shape and the length of the longer side of the rectangular shape is greater than ¼ of the resonant wavelength of the antenna system.

3. The antenna system according to claim 1, wherein the distance between the first side of the second housing and the first connecting element is determined such that the antenna system resonates in a target frequency band.

4. The antenna system according to claim 1, wherein the distance between the first housing and the second housing is determined such that the antenna system has a target bandwidth.

5. The antenna system according to claim 1, wherein the first connecting element comprises an inductor.

6. The antenna system according to claim 1, wherein a second side of the second housing is connected to a second power supply element and the antenna system further comprises a second connecting element arranged apart from the second side of the second housing by a predetermined distance to connect the first housing and the second housing to each other.

7. The antenna system according to claim 6, wherein a signal line connected to the ground plane is arranged between the first connecting element and the second connecting element.

8. The antenna system according to claim 1, wherein the first housing and the second housing are foldably combined with each other by using a hinge.

9. An electronic device having a wireless communication function and including an antenna system comprising:
a first housing formed of a conductive material and connected to a ground plane;
a second housing that is arranged apart from the first housing by a predetermined distance and formed of a conductive material and has a first side connected to a first power supply element; and
a first connecting element arranged apart from the first end of the second housing by a predetermined distance to connect the first housing and the second housing to each other.

10. The electronic device according to claim 9, wherein the second housing has a rectangular shape and the length of the longer side of the rectangular shape is greater than ¼ of the resonant wavelength of the antenna system.

11. The electronic device according to claim 9, wherein the distance between the first side of the second housing and the first connecting element is determined such that the antenna system resonates in a target frequency band.

12. The electronic device according to claim 9, wherein the distance between the first housing and the second housing is determined such that the antenna system has a target bandwidth.

13. The electronic device according to claim 9, wherein the first connecting element comprises an inductor.

14. The electronic device according to claim 9, wherein a second side of the second housing is connected to a second power supply element and the antenna system further comprises a second connecting element arranged apart from the second side of the second housing by a predetermined distance to connect the first housing and the second housing to each other.

15. The electronic device according to claim 14, further comprising a signal line arranged between the first connecting element and the second connecting element and connected to the ground plane.

16. The electronic device according to claim 9, wherein the first housing and the second housing are foldably combined with each other by using a hinge.
